(19) United States
(12) Patent Application Publication
(10) Pub. No.: US 2014/0136556 A1
(43) Pub. Date: May 15, 2014

(54) METHODS AND SYSTEMS FOR MONITORING THE SEVERITY OF INFECTION IN A GROUP OF INDIVIDUALS

(71) Applicants: David Hamilton Wyllie, Oxford (GB); Ann Sarah Walker, Oxford (GB); Iryna Schlackow, Oxford (GB)

(72) Inventors: David Hamilton Wyllie, Oxford (GB); Ann Sarah Walker, Oxford (GB); Iryna Schlackow, Oxford (GB)

(73) Assignee: ISIS INNOVATION LIMITED, Oxford, Oxfordshire (GB)

(21) Appl. No.: 14/005,063

(22) PCT Filed: Feb. 13, 2012
(86) PCT No.: PCT/GB2012/050312

§ 371 Date: Jan. 23, 2014

(30) Foreign Application Priority Data
Mar. 18, 2011 (GB) 1104671.1

(51) Int. Cl. G06F 19/00; G06F 17/30

(52) U.S. Cl. CPC G06F 19/3431; G06F 17/30312
USPC 707/754; 707/756

(57) ABSTRACT

A computer-implemented method of monitoring the severity of infection in a group of individuals. A set of data for each individual is obtained, the data comprising at least one piece of diagnostic test data indicating the level of a biomarker associated with the individual's response to infection. The data is then split into a plurality of segments, each segment comprising all data for each individual within a corresponding one of a plurality of time periods. For each segment, a level of the biomarker across the group of individuals during the time period is estimated. The level of the biomarker for each segment to is then determined provide an indication of the change in severity of infection in the group of individuals over time.

### FIELD OF THE INVENTION

The present invention concerns methods and systems for monitoring the severity of infection in a group of individuals. More particularly, but not exclusively, the invention concerns methods of analysing sets of data for individuals from a group, in order to identify increased levels of biomarkers that indicate the severity of infection.

### BACKGROUND OF THE INVENTION

Bacterial diseases are one of the most important causes of illness in humans. It is well known that the genomes, and consequently the clinical behaviours, of many important human pathogens change over time. Consequent changes in the antimicrobial resistance of pathogens have been studied in detail, but changes in the virulence, or severity, of pathogens is also well recognised. It is known to analyse mortality data for a group of individuals who have tested positive for a particular infection, in order to try to assess the severity of the infection. For example, the mortality over a period such as 28 days may be analysed for all patients admitted to a hospital that test positive for a particular infection. A change in mortality may indicate a corresponding change in the severity of that infection. It might also reflect a change in nature of the patients in the group, for example, they were older, and so more likely to die anyway. A further possibility is that the treatment they received became ineffective, for some reason. Therefore, such analysis has limitations when severity is being monitored.

The present invention seeks to provide improved methods and systems for analysing data to monitor the severity of infection in a group of individuals.

### SUMMARY OF THE INVENTION

In accordance with a first aspect of the present invention there is provided a computer-implemented method of monitoring the severity of infection in a group of individuals, comprising the steps of: obtaining a set of data for each individual, the data comprising at least one piece of diagnostic test data indicating the level of a biomarker associated with the individual's response to infection;

splitting the data into a plurality of segments, each segment comprising all data for each individual within a corresponding one of a plurality of time periods;

for each segment, estimating a level of the biomarker across the group of individuals during the time period; and determining the level of the biomarker for each segment to provide an indication of the change in severity of infection in the group of individuals over time.

The data can be obtained, for example, from patient data recorded for hospital patients, which it is becoming more common to be recorded in electronic form. Such data often includes test data giving infection biomarker levels for the patients, as used during diagnosis.

Analysis of the data will be performed by a computer system. By analysing the data, biomarker levels for the group of individuals as a whole can be estimated. By then analysing the change in overall biomarker levels over time, changes in trends in infection severity can be identified. These changes can be used to give a warning of increase in severity, for example.

Preferably, the method further comprises the step of, prior to splitting the data into a plurality of segments, building a data table from the set of data for the individuals. This allows the data to be efficiently processed and analysed.

Advantageously, the level of the biomarker for each segment is estimated by fitting a regression model to the data in the segment. This method of estimation is particularly suited to the analysis of large sets of data of with properties characteristically found in hospital patient data.

Advantageously, when analysis of the level of the biomarker indicates an increasing trend over a predetermined threshold, providing a warning signal to indicate that an increase in the severity of infection has been detected. The pre-determined threshold might, for example, be determined using a statistical model generating a probability that the change is due to chance, or some related alternative hypothesis.

Thus, a computer system implementing the method can analyse hospital data continuously over time as it is gathered, and then provide a warning when a high infection severity level is identified, allowing mitigating steps to be taken by the hospital.

Preferably, the level of the biomarker estimated across the group of individuals is the mean level. Alternatively, the level of the biomarker estimated may be the quantile. The quantile may be the 75^{th} or 90^{th} quantile, for example.

Preferably, prior to splitting the data table into the plurality of segments the data in the data table is normalised. The data may be normalised by means of the Box-Cox transformation. Advantageously, the level of the biomarker for each segment is analysed using a gridsearch algorithm.

Advantageously, the group of individuals contains only individuals who tested positive for a particular infection. This allows the method to detect severity levels for that particular infection only. Alternatively, no such filtering may be done, in which case data for overall infection severity levels is analysed. This allows the outbreak of an infection that is not already specifically being monitored for to be detected. In either alternative, some filtering of data may be done, for example to remove data for patients with other conditions that may adversely affect the data collected. This may be done by identifying patients who were diagnosed with a particular condition, or who attended a particular clinic of the hospital. Alternatively or additionally, patient data for which the diagnostic test data is outside pre-determined boundaries may be omitted. Other suitable criteria for omitting patient data likely to adversely affect the effectiveness of the method could be used.

Advantageously, the method may be used to monitor the severity of the Clostridium difficile infection. The biomarker may be neutrophil count. Alternatively, the biomarker may be creatinine concentration.

In accordance with a second aspect of the present invention there is provided a computer system for monitoring the severity of infection in a group of individuals, comprising:

data storage apparatus for storing a set of data for each individual, the data comprising at least one piece of diagnostic test data indicating the level of a biomarker associated with the individual's response to infection;

processing apparatus for processing the data in the data storage apparatus, the processing apparatus being arranged to:

split the data into a plurality of segments, each segment comprising all data for each individual within a corresponding one of a plurality of time periods;

for each segment, estimate a level of the biomarker across the group of individuals during the time period;

determine the level of the biomarker for each segment;

provide an indication of the severity of infection in the group of individuals over time.

The computer system may be a single personal computer. Alternatively, the computer system may be a plurality of computing devices, which may be located together or may be geographically distributed and connected by a network such as a local area network or the Internet, for example. Similarly, the data storage apparatus may be a memory in a single computing device, or may be the data may be distributed amongst the memories of a plurality of computer devices. Similarly again, the processing apparatus may be a single processor in a single computing device, multiple processors in a single computing device, or multiple processors of multiple computing devices. Where a large amount of data is to be analysed, the analysis of particular segments (or other subsets of the data) may be entrusted to different computing devices, so that the data can be processed in parallel.

Preferably, the data storage apparatus is arranged to store the data in a data table.

Advantageously, the processing apparatus is arranged to estimate the level of the biomarker for each segment by fitting a regression model to the data in the segments. Alternatively, those skilled in the art will recognise that alternative mathematical algorithms may be used for similar purpose, such as various Bayesian algorithms (Eckley, I. A., P. Fearnhead, R. Killick (2011), Analysis of changepoint models, In D. Barber, T. Cemgil, S. Chiappa (Eds.) Probabilistic Methods for Time-Series Analysis; Bayesian Time Series Models, Cambridge University Press, Fearnhead, P. and Z. Liu (2007); and Online inference for multiple changepoint problems, J. Roy, Stat. Soc. Ser. B, 69, 589-605).

Advantageously, the system further comprises signalling apparatus to provide a warning signal to indicate that an increase in the severity of infection has been detected when analysis of the level of the biomarker indicates an increasing trend over a pre-determined threshold.

Preferably, the level of the biomarker estimated across the group of individuals is the mean level. Preferably, the processing apparatus is further arranged to normalising the data prior to splitting the data into the plurality of segments. Preferably, the processing apparatus is arranged to determine the level of the biomarker for each segment using a gridsearch algorithm.

Advantageously, the processing apparatus is further arranged to filter the data so that the data into the plurality of segments contains data only from individuals who tested positive for a particular infection. Advantageously, the particular infection is Clostridium difficile.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 is a flowchart showing a method of monitoring the severity of the bacterial infection Clostridium difficile according to a first embodiment of the invention;

FIG. 2 is a graph showing the results of applying the gridsearch algorithm to a set of data for the neutrophil level biomarker, in accordance with the method of FIG. 1.

### DETAILED DESCRIPTION

When humans become infected with pathogens such as bacteria, a stereotyped response occurs. This is known as “innate immune response” by immunologists and molecular biologists, or as “sepsis” by clinicians, for example. The severity of the innate immune response may be reflected by various bodily changes that can be measured by laboratory tests on samples taken from patients (such as blood samples), to provide values such as peripheral blood white cell count, neutrophil count, and urea and creatinine concentrations. These values are known as “biomarkers”. Such test results are commonly used in the diagnosis of infections, for example as data used in critical illness scoring systems.

It has recently become more common for data relating to hospital patients to be collected in electronic form. Such patient data often includes personal data (such as name, age) and admission data (such as the date of admission, clinician seen), and also diagnosis data as described above. There are thus now becoming available collections of such data in electronic form.

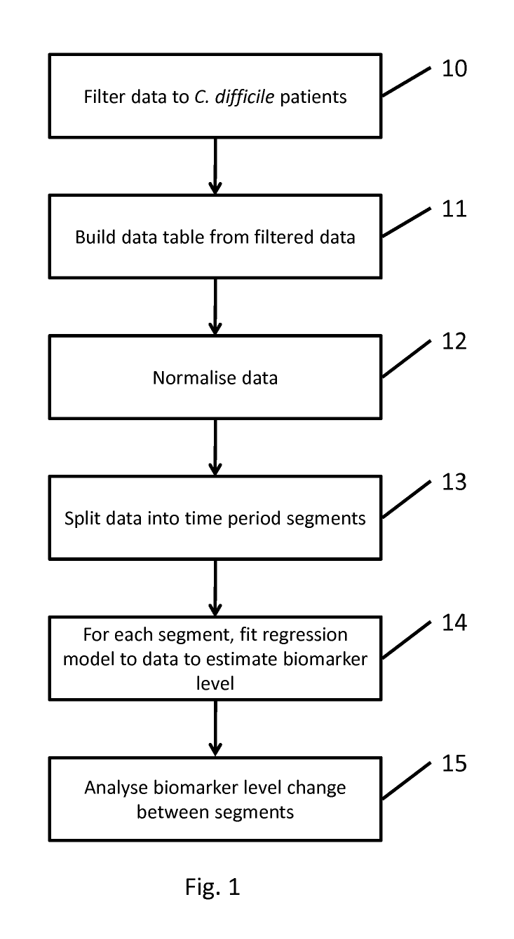

A method of analysing such a collection of patient data in accordance with a first embodiment of the present invention is now described, with reference to the flowchart of FIG. 1. The method is used to monitor the severity of the bacterial infection Clostridium difficile (C. difficile) by analysing patient data for patients admitted to a hospital.

First, the data is filtered so that only data for patients diagnosed with C. difficile remains (step 10). This means that (barring false diagnoses) the biomarkers present in the diagnosis data should relate to innate immune responses of the patients to C. difficile. The data may be further filtered to remove data for patients with conditions that are likely to have a significant effect on the test results, such as patients admitted to oncological and renal specialities, or those where the test results are outside pre-determined ranges.

Next, the filtered data is used to construct a data table upon which the analysis will be performed (step 11). The data in the data table is then normalised, for example using a Box-Cox transformation (Box, George E. P.; Cox, D. R. (1964), An analysis of transformations, Journal of the Royal Statistical Society, Series B 26 (2): 211-252) (step 12). Alternatively, any other suitable normalising transformation could be used, or the data could not be normalised at all.

The data is then split into segments corresponding to diagnosis data collected over different time periods (step 13). Each segment may contain diagnosis data from any tests performed in a particular month, for example. Then, for each segment of data, a regression model is fitted to the data in the segment using well-known techniques (Crawley, M. J. (2009) The R book, Wiley), to estimate the mean levels of the biomarkers in the diagnosis data. For example, linear or non-linear regressions can be fitted. This gives an estimate of the biomarker levels across the group of individuals in the filtered data set for the particular time period. In alternative analyses, a quantile regression model (Koenker, R. (2005), Quantile Regression, Cambridge University Press) may be used in order to estimate a quantile, such as the 75^{th} or 90^{th} quantile for example.

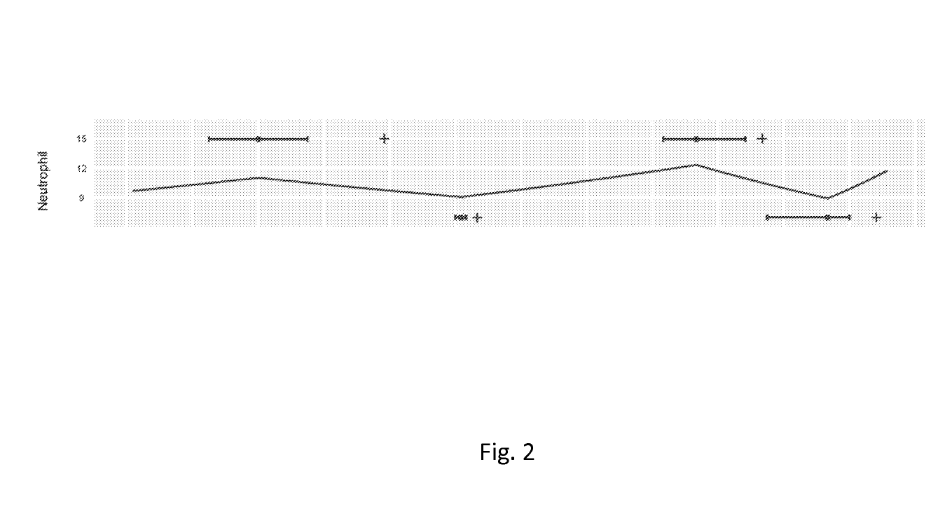

Next, to identify changes in trends in biomarker levels (such as apparent increases or decreases), a gridsearch algorithm (Auger I. E., Lawrence C. E. (1989), Algorithms for the optimal identification of segment neighborhoods, Bulletin of Mathematical Biology 51(1), 39-54.) is performed on the regression models. The gridsearch algorithm considers all possible joinpoint models with joinpoints fitted every three months, where an upper number of joinpoints (for example four) is pre-determined. The best fitting model is then chosen using an information criterion, for example as described in Schwarz, Gideon E. (1978), Estimating the dimension of a model, Annals of Statistics 6 (2): 461-464; or Akaike, Hirotugu (1974), A new look at the statistical model identification, IEEE Transactions on Automatic Control 19 (6): 716-723. A Graph showing the results of applying the gridsearch algorithm to a set of data for the neutrophil level biomarker are shown in FIG. 2.

The method described above can be used to monitor the severity of C. difficile by analysing patient data received over time, for example providing a warning if it is detected that severity is increasing.

A method of analysing a collection of patient data in accordance with a second embodiment of the present invention is similar to the first embodiment, except that in this case patient data is not filtered in the first step, or at least is not filtered to data for patients diagnosed with C. difficile only. In this embodiment, changes in biomarker levels generally can be detected, which can be used to detect the outbreak of a pathogen that is not already being monitored for specifically.

In further embodiments, the analysis of the data is further used to make estimations of factors related to general pathogen severity levels, such as expected mortality rates or expected hospital inpatient stay durations.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

1. A computer-implemented method of monitoring the severity of infection in a group of individuals, comprising the steps of:
obtaining a set of data for each individual, the data comprising at least one piece of diagnostic test data indicating the level of a biomarker associated with the individual's response to infection;
splitting the data into a plurality of segments, each segment comprising all data for each individual within a corresponding one of a plurality of time periods;
for each segment, estimating a level of the biomarker across the group of individuals during the time period; and
determining the level of the biomarker for each segment to provide an indication of the change in severity of infection in the group of individuals over time.

2. A method as claimed in claim 1, further comprising the step of, prior to splitting the data into a plurality of segments, building a data table from the set of data for the individuals.

3. A method as claimed in claim 1, wherein the level of the biomarker for each segment is estimated by fitting a regression model to the data in the segment.

4. A method as claimed in claim 1, further comprising the step of, when analysis of the level of the biomarker indicates an increasing trend over a pre-determined threshold, providing a warning signal to indicate that an increase in the severity of infection has been detected.

5. A method as claimed in claim 1, wherein the level of the biomarker estimated across the group of individuals is the mean level.

6. A method as claimed in claim 1, further comprising the step, prior to splitting the data table into the plurality of segments, of normalising the data in the data table.

7. A method as claimed in claim 1, wherein the level of the biomarker for each segment is analysed using a gridsearch algorithm.

8. A method as claimed claim 1, wherein the group of individuals contains only individuals who tested positive for a particular infection.

9. A method of monitoring the severity of the Clostridium difficile infection in a group of individuals using the method of any preceding claim claim 1.

10. A computer system for monitoring the severity of infection in a group of individuals, comprising:
data storage apparatus for storing a set of data for each individual, the data comprising at least one piece of diagnostic test data indicating the level of a biomarker associated with the individual's response to infection;
processing apparatus for processing the data in the data storage apparatus, the processing apparatus being arranged to:
split the data into a plurality of segments, each segment comprising all data for each individual within a corresponding one of a plurality of time periods;
for each segment, estimate a level of the biomarker across the group of individuals during the time period;
determine the level of the biomarker for each segment;
provide an indication of the severity of infection in the group of individuals over time.

11. A system as claimed in claim 10, wherein the data storage apparatus is arranged to store the data in a data table.

12. A system as claimed in claim 10, wherein the processing apparatus is arranged to estimate the level of the biomarker for each segment by fitting a regression model to the data in the segment.

13. A system as claimed in claim 10, further comprising signalling apparatus to provide a warning signal to indicate that an increase in the severity of infection has been detected when analysis of the level of the biomarker indicates an increasing trend over a pre-determined threshold.

14. A system as claimed in claim 10, wherein the level of the biomarker estimated across the group of individuals is the mean level.

15. A system as claimed in claim 10, wherein the processing apparatus is further arranged to normalising the data prior to splitting the data into the plurality of segments.

16. A system as claimed in claim 10, wherein the processing apparatus is arranged to determine the level of the biomarker for each segment using a gridsearch algorithm.

17. A system as claimed in claim 10, wherein the processing apparatus is further arranged to filter the data so that the data into the plurality of segments contains data only from individuals who tested positive for a particular infection.

18. A system as claimed in 17, wherein the particular infection is Clostridium difficile.
